(19) United States
(12) Patent Application Publication
(10) Pub. No.: US 2022/0204016 A1
(43) Pub. Date: Jun. 30, 2022

(54) ENHANCED VEHICLE OPERATION

(71) Applicant: Ford Global Technologies, LLC, Dearborn, MI (US)

(72) Inventors: Jeremy Lerner, Southfield, MI (US); Tracie Renea Conn, Grosse Pointe Woods, MI (US); Scott Huggins, Novi, MI (US)

(73) Assignee: Ford Global Technologies, LLC, Dearborn, MI (US)

(21) Appl. No.: 17/134,919

(22) Filed: Dec. 28, 2020

(51) Int. Cl. B60W 60/00; G07C 5/00; G07C 5/08; G05B 13/02; B60W 40/08; B60W 30/095; B60W 30/14; G01C 21/00

(52) U.S. Cl. CPC B60W 60/001; B60W 2520/125; G07C 5/0841; G05B 13/0265; B60W 40/08; B60W 30/0956; B60W 30/143; G01C 21/3815; B60W 60/0059; B60W 60/0053; B60W 2510/202; B60W 2540/225; B60W 2554/80; B60W 2552/53; G07C 5/008

(57) ABSTRACT

A computer includes a processor and a memory storing instructions executable by the processor to receive operating data including occupant data indicating one or more occupant actions to operate a vehicle and location data specifying a location of a vehicle during collection of the occupant data, assign the operating data to a respective set in a plurality of sets, each set including operating data collected during a different specified period of time from other sets, input the plurality of sets to a machine learning program trained to output an identification of a hazard at a specified location, the hazard being a roadway condition or an obstacle that changes operation of the vehicle from a default operation, output the hazard at the specified location from the machine learning program, and send a message to a vehicle including the hazard at the specified location.

### BACKGROUND

Vehicles can be equipped with computing devices, networks, sensors and controllers to acquire data regarding the vehicle's environment and to operate the vehicle based on the data. Vehicle sensors can provide data concerning routes to be traveled and objects to be avoided in the vehicle's environment. Operation of the vehicle can rely upon acquiring accurate and timely data regarding objects in a vehicle's environment while the vehicle is being operated on a roadway.

### BRIEF DESCRIPTION OF THE DRAWINGS

FIG. 1 is a block diagram of an example system for operating a vehicle.

FIG. 2 is a top-down view of an example roadway.

FIG. 3 is a block diagram of an example server programmed to identify a hazard on the roadway.

FIG. 4 is a diagram of an example neural network.

FIG. 5 is a block diagram of an example process for training the example neural network.

FIG. 6 is a block diagram of an example process for operating a vehicle with the neural network.

### DETAILED DESCRIPTION

A system includes a computer including a processor and a memory, the memory storing instructions executable by the processor to receive operating data from a vehicle, the operating data including occupant data indicating one or more occupant actions to operate a vehicle and location data specifying a location of a vehicle during collection of the occupant data, assign the operating data to a respective set in a plurality of sets, each set including operating data collected during a different specified period of time from other sets, input the plurality of sets to a machine learning program trained to output an identification of a hazard at a specified location, the hazard being a roadway condition or an obstacle that changes operation of the vehicle from a default operation, output the hazard at the specified location from the machine learning program, and send a message to the vehicle including the hazard at the specified location output from the machine learning program.

The system can further include a vehicle computer of the vehicle programmed to receive the hazard at the specified location and to transition from a first operation mode to a second operation mode of the vehicle based on the hazard.

The first operation mode can be a fully autonomous mode and the second operation mode can be a semiautonomous mode.

The machine learning program can be trained to assign each of the plurality of sets to one of a plurality of hazard classes, each hazard class indicating a specified operation mode for the vehicle at the specified location.

The hazard classes can include a manual operation mode class indicating that a vehicle computer of the vehicle operates the vehicle in a manual mode at the specified location.

The hazard classes can include a limited autonomous mode class in which a vehicle computer of the vehicle operates the vehicle in a fully autonomous mode at a lower speed than a posted speed limit at the specified location.

The instructions can further include instructions to include the hazard in a map and to include the map in the message to the vehicle.

The map can be a high-resolution map that includes geo-coordinates at a resolution that is finer than a second resolution of second geo-coordinates from an external server.

The operating data can include at least one of a steering wheel torque, a position of an occupant's hand on a steering wheel, a grip force of the occupant's hand on the steering wheel, a lateral acceleration of the vehicle, a gaze angle of the occupant, or a distance between the vehicle and another vehicle.

The instructions can further include instructions to input, to the machine learning program, second occupant data of occupant actions to operate the vehicle collected during a second period of time that is different than the specified period of time.

The instructions can further include instructions to receive occupant data of a respective occupant of a plurality of vehicles and to input the occupant data of the occupants of the plurality of vehicles to the machine learning program.

The location data can include an identification of a roadway lane in which the vehicle is located.

The instructions can further include instructions to collect image data of one or more markings on a roadway to identify the roadway lane.

The system can further include a vehicle computer of the vehicle programmed to actuate one or more components to move the vehicle away from the hazard.

A method includes receiving operating data from a vehicle, the operating data including occupant data indicating one or more occupant actions to operate a vehicle and location data specifying a location of a vehicle during collection of the occupant data, assigning the operating data to a respective set in a plurality of sets, each set including operating data collected during a different specified period of time from other sets, inputting the plurality of sets to a machine learning program trained to output an identification of a hazard at a specified location, the hazard being a roadway condition or an obstacle that changes operation of the vehicle from a default operation, outputting the hazard at the specified location from the machine learning program, and sending a message to the vehicle.

The method can further include receiving the hazard at the specified location and transitioning from a first operation mode to a second operation mode of the vehicle based on the hazard.

The method can further include including the hazard in a map and including the map in the message to the vehicle.

The method can further include inputting, to the machine learning program, second occupant data of occupant actions to operate the vehicle collected during a second period of time that is different than the specified period of time.

The method can further include receiving occupant data of a respective occupant of a plurality of vehicles and inputting the occupant data of the occupants of the plurality of vehicles to the machine learning program.

The method can further include collecting image data of one or more markings on a roadway to identify the roadway lane.

The method can further include actuating one or more components of the vehicle to move the vehicle away from the hazard.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Operators of vehicles can perform actions in response to identifying a hazard on a roadway. For example, the operators can actuate a steering wheel to steer the vehicles away from a pothole. In another example, the operators can turn their respective heads toward a hazard on an adjacent roadway, increasing a gaze angle relative to forward motion of the vehicle. In yet another example, the operators can actuate a brake to slow the vehicles on a roadway with snow. Detecting the changes to operator behavior can indicate a hazard on the roadway that other vehicles should avoid.

A central server can be programmed with a machine learning program that identifies hazards based on operator behavior data collected by the vehicles. The machine learning program can output a hazard at a specified location based on input operator behavior data. The server can include the identified hazards in a map, and the server can transmit the map to the vehicles. Autonomous vehicles can, based on the map, actuate one or more components to avoid, e.g., move away from, the hazards. The operator data can include timestamps at which the data were collected, and the machine learning program can identify a hazard based on data collected within a specified time period. These time period data, i.e., “time window” data, are more readily analyzed by the machine learning program than data without timestamps. That is, the timestamps allow the machine learning program to identify hazards at locations by filtering out old behavior data during which the hazard may not have been present. Thus, the machine learning program can use the time window operator behavior data to identify hazards for a map used by autonomous vehicles for operation on the roadway.

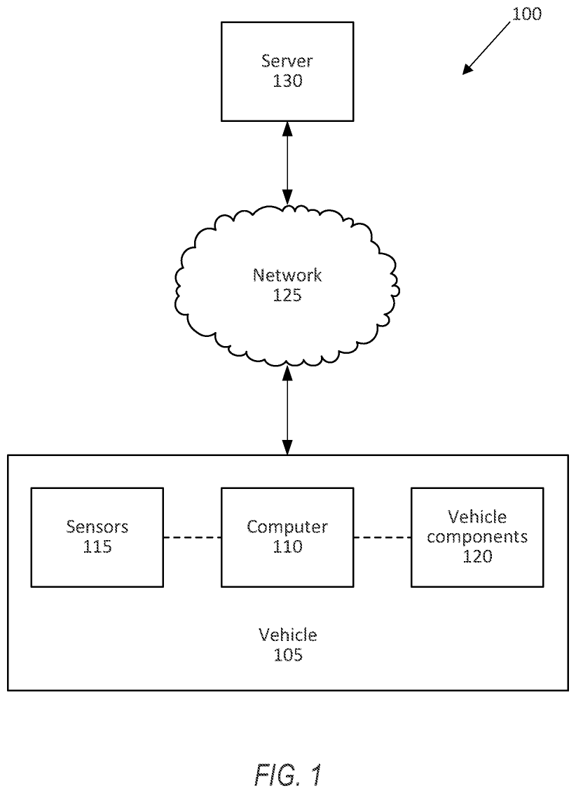

FIG. 1 illustrates an example system 100 for identifying a hazard on a roadway. A computer 110 in a vehicle 105 is programmed to receive collected data from one or more sensors 115. For example, vehicle data may include a location of the vehicle 105, data about an environment around a vehicle 105, data about an object outside the vehicle 105 such as another vehicle 105, etc. A vehicle location is typically provided in a conventional form, e.g., geo-coordinates such as latitude and longitude coordinates obtained via a navigation system that uses the Global Positioning System (GPS). Further examples of data can include measurements of vehicle systems and components, e.g., a vehicle velocity, a vehicle trajectory, etc.

The computer 110 is generally programmed for communications on a vehicle network, e.g., including a conventional vehicle communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with the network, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected in a vehicle 105. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, a vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering subsystem as described below (e.g., that may include one or more of a steering wheel, a steering rack, etc.), a brake component, a park assist component, an adaptive cruise control component, an adaptive steering component, a movable seat, and the like. Components 120 can include computing devices, e.g., electronic control units (ECUs) or the like and/or computing devices such as described above with respect to the computer 110, and that likewise communicate via a vehicle network.

The vehicle computer 110 can operate and/or monitor the vehicle 105 in one of a fully autonomous mode, a semiautonomous mode, or a non-autonomous mode, i.e., can control and/or monitor operation of the vehicle 105, including controlling and/or monitoring components 120. A fully autonomous mode is defined as one in which each of vehicle propulsion (typically via a powertrain including an electric motor and/or internal combustion engine), braking, and steering are controlled by the computer 110. A semi-autonomous mode is one in which at least one of vehicle propulsion (typically via a powertrain including an electric motor and/or internal combustion engine), braking, and steering are controlled at least partly by the computer 110 as opposed to a human operator. In a non-autonomous mode, i.e., a manual mode, the vehicle propulsion, braking, and steering are controlled by the human operator.

The system can further include a network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 125 include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

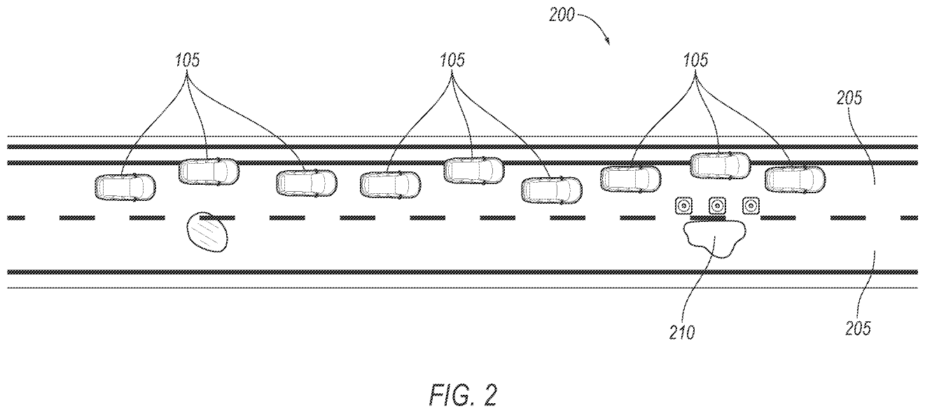

FIG. 2 is a top-down view of an example roadway 200. The roadway 200 includes a plurality of roadway lanes 205. A plurality of vehicles 105 travel on the roadway 200 in the roadway lanes 205. The roadway 200 can include a hazard 210. In this context, a “hazard” is a physical feature in or on a road that changes operation of the vehicle 105 from a default operation. “Default” operation is operation of the vehicle 105 on a roadway 200 without roadway conditions or obstacles that would cause an occupant of the vehicle 105 to change at least one of a speed or a steering operation of the vehicle 105. As the vehicles 105 travel along the roadway 200, the vehicles 105 can change operation from the default operation to avoid the hazards 210, e.g., by slowing down and/or steering away from the hazard 210. For example, if the hazard 210 is a pothole, the vehicles 105 can slow to below a posted speed limit and move beyond a lane marker into an adjacent roadway lane 205. In another example, if the hazard 210 is snow on the roadway 200, a relative distance between the vehicles 105 can decrease relative to a distance when there is no snow on the roadway 200.

Each vehicle 105 can include a respective computer 110, as described above, that can collect operating data from the vehicle 105, e.g., from controllers and/or sensors via a vehicle network. In this context, “operating data” are physical descriptions or measurements of one or more occupant actions when operating the vehicle 105. Each vehicle 105 can include an occupant that can perform one or more actions that can indicate the presence of the hazard 210. For example, the occupant can move a steering wheel, generating a steering wheel torque and a change in lateral acceleration, that turns the vehicle 105 away from the hazard 210. In another example, the occupant can gaze (i.e., direct their eyes) toward the roadway 200, generating a gaze angle between a gaze direction of the occupant and a longitudinal axis of the vehicle 105. In yet another example, the occupant can release an accelerator pedal and/or actuate a brake pedal, reducing a vehicle speed and increasing a distance between the vehicle 105 and another vehicle 105. The computer 110 can collect data about the steering wheel torque, a position of an occupant's hand on the steering wheel, a grip force of the occupant's hand on the steering wheel, change in lateral and longitudinal acceleration, gaze angle, vehicle lateral and longitudinal speed, and distance between the vehicle 105 and other vehicles 105 as operating data. The operating data thus indicate actions performed by the occupant as opposed to actions performed upon receiving autonomous or semiautonomous instructions from the computer 110. Example operating data are shown in Table 1 below:

TABLE 1
Operating data

| Type of Data | Examples of Operating Data |
|---|---|
| Steering wheel torque | Torque data, maximum torque value, average |
| | torque value |
| Distance between vehicle and lane marking | Distance data, average distance value |
| Distance between vehicle and another target | Distance data, average distance value |
| vehicle | |
| Lateral acceleration | Acceleration data, maximum lateral |
| | acceleration |
| Longitudinal acceleration | Acceleration data, maximum longitudinal |
| | acceleration |
| Vehicle speed | Speed data, maximum speed value, average |
| | speed value |
| Phone call status | Call in progress, call not in progress |
| Occupant gaze | Gaze angle relative to longitudinal axis of |
| | vehicle |
| Operation mode transition | Time at which semiautonomous mode |
| | requested, time at which manual mode |
| | requested, input to human-machine interface |
| | to transition to a different operation mode, |
| | change in brake pressure and subsequent |
| | transition instruction from computer |
| Entertainment subsystem status | Current volume level of entertainment |
| | subsystem, time at which volume level |
| | changed |
| Interior light status | Flag indicating whether interior light actuated |
| Vehicles in roadway lanes | Number of vehicles detected in each roadway |
| | lane |
| Refusal to implement lane change | Identification of roadway lane that differs |
| | from roadway lane recommended by |
| | computer |
| Steering wheel grip and position | Capacitive sensor output indicating a force |
| | applied to a steering wheel, capacitive sensor |
| | output indicating a location of an occupant's |
| | hand on the steering wheel relative to a |
| | neutral location; image data of the location of |
| | the occupant's hand, pressure sensor output |
| | indicating a force and/or location of the |
| | occupant's hand |

Table 1 lists operating data collected and/or calculated during operation of the vehicle 105 at different timestamps and that can be aggregated data for a specified period of time, as described below. That is, the computer 110 can store the operating data and timestamps at which the data were collected, and the computer 110 can identify a single value representing all of a type of operating data within a specified period of time, e.g., a maximum value, an average value, etc.

The computer 110 can store location data specifying a location at which the computer 110 collected operation data. In this context, “location data” include data specifying an absolute and/or a relative location at which the operating data are collected. For example, the location data can include geo-coordinates of the vehicle 105 during collection of the operating data. In another example, the location data can include an identification of a roadway lane 205 in which the vehicle 105 and/or the hazard 210 is located. The computer 105 can collect image data of the roadway 200, including lane markings indicating boundaries between the roadway lanes 205. The computer 110 can, based on the collected image data of the lane markings, identify a current roadway lane 205 in which the vehicle 105 is traveling.

The computer 110 can transmit the operating data to an external server 130 via the network 125, as shown in FIG. 1. The operating data collected by the computer 110 can include the occupant data describing occupant actions indicating the hazard 210 and location data indicating a location at which the computer 110 collected the data. The external server 130 can identify the hazards 210 in the roadway 200, as described below, with a machine learning program.

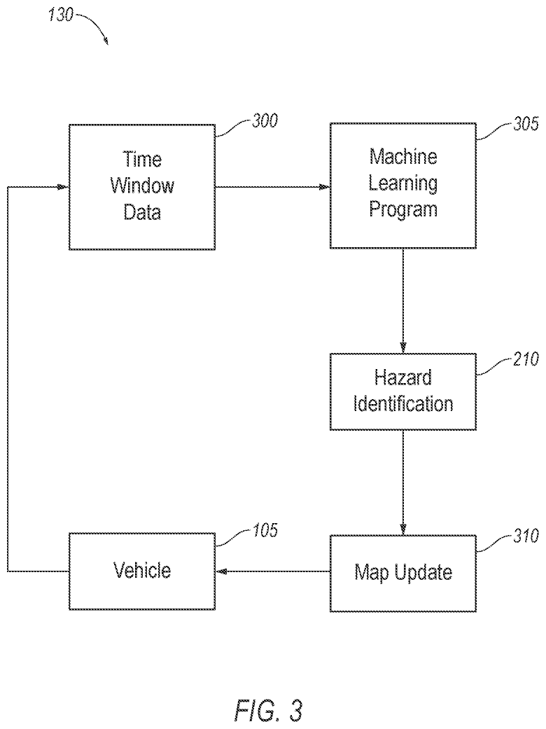

FIG. 3 is a block diagram of an example external server 130 that identifies a hazard 210 on a roadway 200. The server 130 receives the operating data from each of a plurality of vehicles 105, as described above. The server 130 can “localize” the operating data, i.e., to determine a geographic area of a potential hazard 210 based on the location data and the occupant data received from the vehicles 105. The “geographic area” can be defined by a boundary surrounding an area in which geo-coordinates and roadway lane 205 data for specific operating data indicating a hazard 210 are located. For example, when the server 130 receives a plurality of operating data indicating a change in lateral acceleration, the server 130 can identify the location data at which the lateral acceleration data were collected and identify a boundary encircling all of geo-coordinates and roadway lane data 205 listed in the location data.

The server 130 can assign the operating data to one of a plurality of sets 300 based on a period of time during which the respective computers 110 of the vehicles 105 collected the data. A “set” in this context is a collection of data from the vehicles 105 that have respective timestamps within a specified period of time. The server 130 can generate a plurality of sets 300 of operating data, and each set 300 of operating data includes data collected during a different specified period of time from each other set 300 of operating data. These sets 300 of operating data generated within the specific period of time are “time window” data sets 300, and each set 300 of time window data includes operating data for one of the specified period of time. The period of time for each time window set 300 can be determined based on, e.g., traffic patterns on the roadway 200. For example, the period of time for each set can be a six-hour period starting before a commute period on the roadway 200 and ending after the commute period, e.g., from 6:00 AM to 12:00 PM. In another example, the period of time can be a three-hour period directed to the commute period, e.g., 6:00 AM to 9:00 AM, and another period of time can be the following three-hour period that can have less traffic than the commute period, e.g., 9:00 AM to 12:00 PM. The operating data in the time window set 300 can include individual data collected at different timestamps within the specified period of time and/or a single aggregated value for each type of data, e.g., an average distance to a lane marking, a maximum lateral acceleration, etc., as shown in Table 1.

The time window sets 300 of operating data can include a current set 300 and historical sets 300. In this context, the “current” set 300 of data includes data for which the specified period of time is a most recent completed period of time, i.e., the period of time that most recently completed relative to a current time. The “historical” sets 300 of data are the sets of data for specified periods of time prior to the current set of data. Using the current and historical sets 300, the server 130 can determine whether a hazard 210 detected during the historical sets 300 remains in the current set 300 and whether the hazard 210 may currently remain on the roadway 200. That is, the server 130 can determine, based on the time window sets 300 of operating data, whether there is a hazard 210 currently on a roadway 200. The current set 300 together with one or more historical sets 300 thus provide data for a plurality of respective time periods.

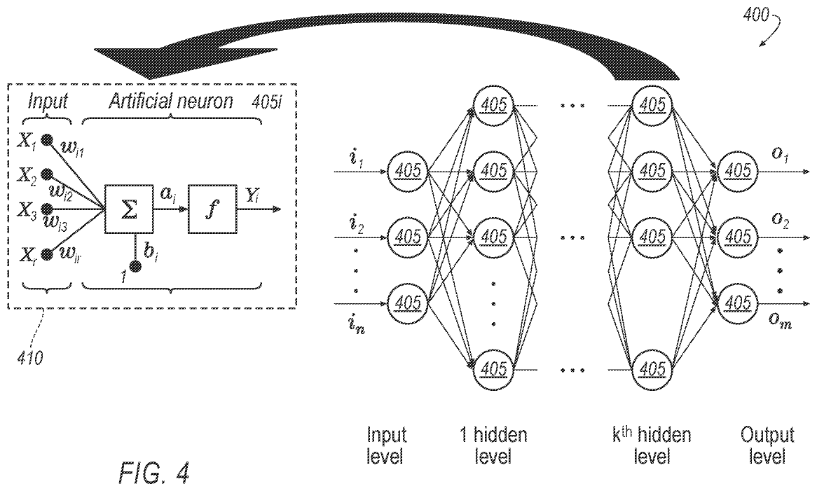

The server 130 can input the time window sets 300 of operating data to a machine learning program 305. The machine learning program 305 is trained to output an identification of a hazard 210 at a specified location. The machine learning program 305 can be a neural network, such as a deep neural network 400 as described below. The machine learning program 305 can be trained with a conventional neural network training technique, such as described below and shown in FIG. 4.

The machine learning program 305 can be trained to assign each of the time window sets 300 to one of a plurality of hazard classes. A “hazard class” is a specified operation mode for the vehicle 105 to avoid the hazard 210, where an “operation mode” specifies a level of autonomous operation. That is, the hazard class indicates an operation mode of the vehicle 105 to be activated to avoid the hazard 210 without identifying the specific hazard 210. Table 2 below lists example hazard classes output by the machine learning program 305 and the associated operation modes with the hazard classes:

TABLE 2
Hazard Classes

| Hazard Class | Operation Mode |
|---|---|
| Class I | Fully Autonomous |
| Class II | Limited Autonomous |
| Class III | Semiautonomous |
| Class IV | Manual |

The “fully autonomous,” “semiautonomous,” and “manual modes” are described above. A “limited autonomous” mode is a fully autonomous mode with one or more limits to autonomous operation. In the limited autonomous mode, the computer 110 operates the propulsion, the brake, and the steering without input from the occupant and below predetermined limits to the operation that are not used in the fully autonomous mode. For example, in the limited autonomous mode, the vehicle 105 could actuate the propulsion but at a speed that is lower than a posted speed limit. In another example, in the limited autonomous mode, the vehicle 105 can actuate a brake at a higher brake pressure than in the fully autonomous mode to provide additional braking to slow the vehicle 105. Thus, the fully autonomous or the limited autonomous modes, the computer 110 actuates one or more components 120 to avoid the hazard 210 without input from the occupant.

The server 130 can update a map 310 with the identified hazards 210 and/or hazard classes. In this context, a “map” is a set of data, i.e., a plurality of bits encoding information, that includes information about a specific geographic area. For example, a map 310 could be stored in what is conventionally referred to as a file or data file. The data can include, e.g., geo-coordinate data, roadway lane 205 data, lane marking data, landmarks, hazards 210, etc. The server 130 can send messages to one or more vehicles 105 that include the map and identified hazards 210 at the specified locations. The map can be a high-resolution map that has a finer resolution of geo-coordinates than a conventional geo-coordinate map, e.g., from a GPS server.

Upon receiving the map 310 with the identified hazards 210, the computer 110 can compare a current location of the vehicle 105 to the specified locations of the hazards 210 in the map. When the current location of the vehicle 105 is within a distance threshold of the location of one of the identified hazards 210, the computer 110 can actuate one or more components 120 to move the vehicle away from the hazard 210. For example, the computer 110 can determine the hazard class of the hazard 210 and can then transition to the operation mode associated with the hazard class. The computer 110 can identify the hazard class as, e.g., class III, and the computer 110 can transition from a fully autonomous mode to a semiautonomous mode based on the identified hazard class. In another example, the computer 110 can actuate a steering component to turn the vehicle 105 away from the hazard 210, as shown in FIG. 2. In yet another example, the computer 110 can adjust a planned path of the vehicle 105 to avoid the roadway 200 on which the computer 110 identified the hazard 210.

FIG. 4 is a diagram of an example a deep neural network (DNN) 400. The machine learning program 305 described above may be a deep neural network such as the DNN 400. That is, the machine learning program 305 may be trained according to the conventional deep learning techniques described below. The DNN 400 can be trained in a server 130.

The DNN 400 can be a software program that can be stored in a memory and executed by a processor included in the server 130, for example. The DNN 400 can include n input nodes 405, each accepting a set of inputs i (i.e., each set of inputs i can include one or more inputs X). The DNN 400 can include m output nodes (where m and n may be, but typically are not, a same natural number) provide sets of outputs o₁ . . . oₘ. The DNN 400 includes a plurality of layers, including a number k of hidden layers, each layer including one or more nodes 405. The nodes 405 are sometimes referred to as artificial neurons 405, because they are designed to emulate biological, e.g., human, neurons. The neuron block 410 illustrates inputs to and processing in an example artificial neuron 405i. A set of inputs X₁ . . . Xᵣ to each neuron 405 are each multiplied by respective weights wᵢ₁ . . . wᵢᵣ, the weighted inputs then being summed in input function Σ to provide, possibly adjusted by a bias bᵢ, net input aᵢ, which is then provided to activation function ƒ, which in turn provides neuron 405i output Yᵢ. The activation function ƒ can be a variety of suitable functions, typically selected based on empirical analysis. As illustrated by the arrows in FIG. 4, neuron 405 outputs can then be provided for inclusion in a set of inputs to one or more neurons 405 in a next layer.

The DNN 400 can be trained to receive input data, e.g., sets of operating data, and to then provide output based on that input. That is, the DNN 400 can be trained with ground truth data, i.e., data deemed to describe a real-world condition or state. Weights w can be initialized by using a Gaussian distribution, for example, and a bias b for each node 405 can be set to zero. Training the DNN 400 can including updating weights and biases via conventional techniques such as back-propagation with optimizations.

A set of weights w for a node 405 together are a weight vector for the node 405. Weight vectors for respective nodes 405 in a same layer of the DNN 400 can be combined to form a weight matrix for the layer. Bias values b for respective nodes 405 in a same layer of the DNN 400 can be combined to form a bias vector for the layer. The weight matrix for each layer and bias vector for each layer can then be used in the trained DNN 400.

In the present context, the ground truth data used to train the DNN 400 could include the time window data described above. For example, a computer 110 can use reference data that can be labeled for training the DNN 400, i.e., tags can be specified identifying one or more hazards 210 and/or hazard classes. The reference data can be operating data collected by the server 130 from a plurality of vehicles 105 and manually labeled with the hazard 210 from which the operating data were collected. The DNN 400 can then be trained to output data values that correlate to a predicted hazard 210, and the output data values can be compared to the annotations to identify a difference, i.e., a cost function of the output data values and the input annotated operating data. The weights w and biases b can be adjusted to reduce the output of the cost function, i.e., to minimize the difference between the output data values and the annotations in the input operating data. When the cost function is minimized, the server 130 can determine that the DNN 400 is trained.

Additionally or alternatively, the machine learning program 305 can include programming with a different machine learning algorithm, e.g., Long Short-Term Memory (LSTM), recurrent neural network algorithms (RNN), variational autoencoders, gradient-boosted trees, etc. The machine learning program 305 can, with the machine learning algorithms, identify one or more hazards 210 based on operating data at specific subsets of time within the time window, and can identify the hazards 210 based on the operating data and specific times at which the operating data were collected. That is, if the time window is defined by a period of time elapsed from 6:00 AM to 12:00 PM, the machine learning program 305 can identify hazards 210 based on operating data occurring at a second time window that takes place within the time window, e.g., from 8:00 AM to 10:00 AM. For example, the operating data from 6:00 AM to 12:00 AM can indicate that a first hazard 210 has occurred during the time window, and the machine learning program 305 can, based on the operating data from 8:00 AM to 10:00 AM, determine that the first hazard 210 has resolved.

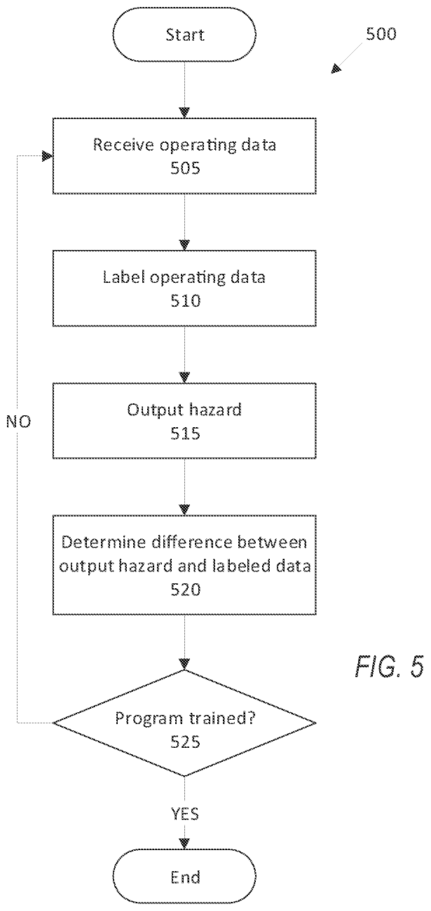

FIG. 5 is an example process 500 for training a machine learning program 305 that outputs a hazard 210 on a roadway 200 from input operating data from a plurality of vehicles 105. The process 500 begins in a block 505, in which a server 130 receives operating data from respective computers 110 of one or more vehicles 105. The operating data are physical measurements of data indicating one or more occupant actions to operate the vehicle 105, and the computer 110 can transmit the operating data to the server 130 via a network, e.g., the network 125. The operating data can include, e.g., a steering wheel torque, a lateral acceleration, etc. The operating data can include all data collected within a specified period of time and/or a single aggregated value for a specific type of data. For example, the operating data can include all speed data of the vehicle 105 collected for a specified period of time and/or a single average speed value for the vehicle 105.

Next, in a block 510, the operating data are labeled with a hazard 210 from which the operating data were collected. The operating data can be labeled manually, i.e., annotations indicating the hazard 210 can be inserted as text labels to the operating data. The hazard 210 is ground truth data, as described above, identified prior to or while the vehicles 105 collect the operating data.

Next, in a block 515, the machine learning program 305 outputs an identification of a hazard 210 based on the input operating data. As described above, the machine learning program 305 can be a deep neural network 400 that outputs data values that correlate to a predicted hazard 210. Based on outputs from one or more neurons 405 in the DNN 400, the machine learning program 305 can output a predicted hazard 210.

Next, in a block 520, the server 130 determines a difference between the output hazard 210 and the labeled hazard 210 in the operating data. For example, the server 130 can identify a difference, i.e., a cost function of the output hazards 210 and the input annotated operating data. Weights w and biases b of the DNN 400 can be adjusted to reduce the output of the cost function, i.e., to minimize the difference between the output hazards 210 and the annotations.

Next, in a block 525, the server 130 determines whether the machine learning program 310 is trained. The server 130 can determine that the machine learning program 305 is trained when the cost function is minimized, i.e., when outputs of the cost function are below a specified threshold. The specified threshold can be a percentage value determined by a manufacturer and based on conventional statistical techniques, e.g., 5%. If the server 130 determines that the machine learning program 305 is trained, the process 500 ends. Otherwise, the process 500 returns to the block 505.

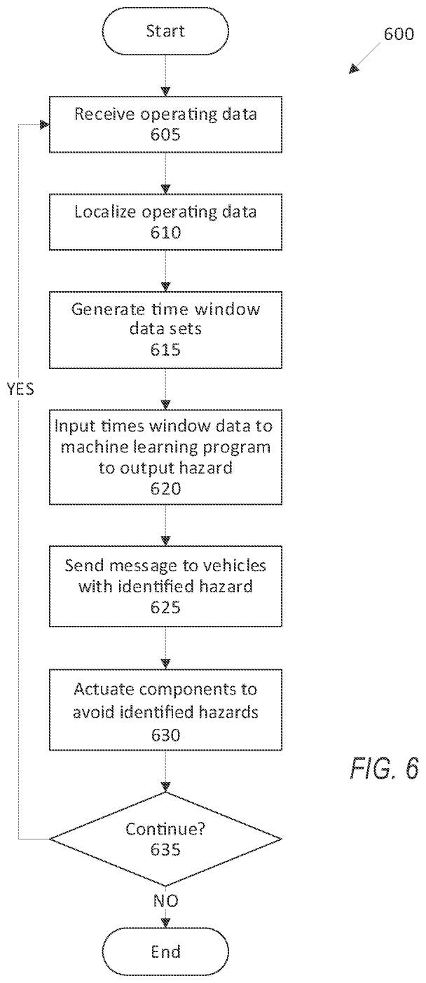

FIG. 6 is a block diagram of an example process 600 for identifying a hazard 210 on a roadway 200. The process 600 begins in a block 605, in which a server 130 receives operating data from respective computers 110 of one or more vehicles 105. As described above, the operating data are data indicating one or more occupant actions to operate the vehicle 105, and the computer 110 can transmit the operating data to the server 130 via a network, e.g., the network 125. The operating data can include, e.g., an average steering wheel torque, a maximum lateral acceleration, etc.

Next, in a block 610, the server 130 localizes the operating data. The computer 110 can transmit location data identifying a location of the vehicle 105 when the operating data were collected. The server 130 can include the location data and the occupant data from one or more vehicles 105 in a set of data, as described above, to identify a geographic region in which a hazard 210 may be located. Localizing the operating data from a plurality of vehicles 105 can improve identification of the location of the hazard 210 by using data from multiple vehicles 105 in a specified geographic area.

Next, in a block 615, the server 130 generates time window data sets 300 of the operating data, including current and historical data sets 300. As described above, the server 130 assigns the operating data to one of a plurality of sets 300 based on a specified period of time, e.g., a six-hour period from 6:00 AM to 12:00 PM. The period of time can be specified based on a time elapsed until a specified amount of operating data are received to identify a hazard 210 and/or a period of time during which occupants travel on the roadway 200 and would operate vehicles 105 to avoid the hazards 210. For example, the specified period of time can be determined based on, e.g., traffic flow on the roadway 200 during a daily commute. The current data set 300 is a data set from a most recent time period, and the historical data sets 300 are data sets from time periods previous to the most recent time period.

Next, in a block 620, the server 130 inputs the time window data sets 300 to a machine learning program 305 trained to output a hazard 210. As described above, the machine learning program 305 can be a neural network trained to output a hazard 210 and/or a hazard class based on the time window data sets 300. For example, the machine learning program 305 can output a hazard class that specifies an operation mode for the vehicles 105 at a specified location at which a hazard 210 is located.

Next, in a block 625, the server 130 sends a message to the vehicles 105 including the identified hazards 210. For example, the server 130 can update a high-resolution map 310 with the identified hazards 210. The server 130 can transmit the high-resolution map 310 to the vehicle 105 via the network 125.

Next, in a block 630, the computers 110 of the vehicles 105 actuate one or more components 120 to avoid the hazards 210 based on the hazards 210 identified in the high-resolution map 310. The computers 110 can transition to an operation mode specified in the hazard class output from the machine learning program 305 and included in the map 310. For example, if the server 130 outputs a hazard 210 that is a class III hazard class, as described above, the computers 110 can transition to a semiautonomous mode of operation.

Next, in a block 635, the server 130 determines whether to continue the process 600. For example, the server 130 can determine to continue the process 600 when a new time period starts. If the server 130 determines to continue, the process 600 returns to the block 605. Otherwise, the process 600 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a computer including a processor and a memory, the memory storing instructions executable by the processor to:
receive operating data from a vehicle, the operating data including occupant data indicating one or more occupant actions to operate a vehicle and location data specifying a location of a vehicle during collection of the occupant data;
assign the operating data to a respective set in a plurality of sets, each set including operating data collected during a different specified period of time from other sets;
input the plurality of sets to a machine learning program trained to output an identification of a hazard at a specified location, the hazard being a roadway condition or an obstacle that changes operation of the vehicle from a default operation;
output the hazard at the specified location from the machine learning program; and
send a message to the vehicle including the hazard at the specified location output from the machine learning program.

2. The system of claim 1, further comprising a vehicle computer of the vehicle programmed to receive the hazard at the specified location and to transition from a first operation mode to a second operation mode of the vehicle based on the hazard.

3. The system of claim 2, wherein the first operation mode is a fully autonomous mode and the second operation mode is a semiautonomous mode.

4. The system of claim 1, wherein the machine learning program is trained to assign each of the plurality of sets to one of a plurality of hazard classes, each hazard class indicating a specified operation mode for the vehicle at the specified location.

5. The system of claim 4, wherein the hazard classes include a manual operation mode class indicating that a vehicle computer of the vehicle operates the vehicle in a manual mode at the specified location.

6. The system of claim 4, wherein the hazard classes include a limited autonomous mode class in which a vehicle computer of the vehicle operates the vehicle in a fully autonomous mode at a lower speed than a posted speed limit at the specified location.

7. The system of claim 1, wherein the instructions further include instructions to include the hazard in a map and to include the map in the message to the vehicle.

8. The system of claim 7, wherein the map is a high-resolution map that includes geo-coordinates at a resolution that is finer than a second resolution of second geo-coordinates from an external server.

9. The system of claim 1, wherein the operating data include at least one of a steering wheel torque, a position of an occupant's hand on a steering wheel, a grip force of the occupant's hand on the steering wheel, a lateral acceleration of the vehicle, a gaze angle of the occupant, or a distance between the vehicle and another vehicle.

10. The system of claim 1, wherein the instructions further include instructions to input, to the machine learning program, second occupant data of occupant actions to operate the vehicle collected during a second period of time that is different than the specified period of time.

11. The system of claim 1, wherein the instructions further include instructions to receive occupant data of a respective occupant of a plurality of vehicles and to input the occupant data of the occupants of the plurality of vehicles to the machine learning program.

12. The system of claim 1, wherein the location data include an identification of a roadway lane in which the vehicle is located.

13. The system of claim 12, wherein the instructions further include instructions to collect image data of one or more markings on a roadway to identify the roadway lane.

14. The system of claim 1, further comprising a vehicle computer of the vehicle programmed to actuate one or more components to move the vehicle away from the hazard.

15. A method, comprising:
receiving operating data from a vehicle, the operating data including occupant data indicating one or more occupant actions to operate a vehicle and location data specifying a location of a vehicle during collection of the occupant data;
assigning the operating data to a respective set in a plurality of sets, each set including operating data collected during a different specified period of time from other sets;
inputting the plurality of sets to a machine learning program trained to output an identification of a hazard at a specified location, the hazard being a roadway condition or an obstacle that changes operation of the vehicle from a default operation;
outputting the hazard at the specified location from the machine learning program; and
sending a message to the vehicle.

16. The method of claim 15, wherein the machine learning program is trained to assign each of the plurality of sets to one of a plurality of hazard classes, each hazard class indicating a specified operation mode for the vehicle at the specified location.

17. The method of claim 16, wherein the hazard classes include a manual operation mode class indicating that a vehicle computer of the vehicle operates the vehicle in a manual mode at the specified location.

18. The method of claim 16, wherein the hazard classes include a limited autonomous mode class in which a vehicle computer of the vehicle operates the vehicle in a fully autonomous mode at a lower speed than a posted speed limit at the specified location.

19. The method of claim 15, further comprising receiving occupant data of a respective occupant of a plurality of vehicles and inputting the occupant data of the occupants of the plurality of vehicles to the machine learning program.

20. The method of claim 15, further comprising actuating one or more components of the vehicle to move the vehicle away from the hazard.
